(19) United States
(12) Patent Application Publication
(10) Pub. No.: US 2010/0147451 A1
(43) Pub. Date: Jun. 17, 2010

(54) USE OF SILANES AS ADHESION PROMOTERS BETWEEN TWO ORGANIC SURFACES

(75) Inventor: Ramon Sanchez Morillo, West Milford, NJ (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/595,067

(22) PCT Filed: Apr. 24, 2008
(86) PCT No.: PCT/US2008/061405

§ 371 Date: Oct. 8, 2009

Related U.S. Application Data
(60) Provisional application No. 60/913,559, filed on Apr. 24, 2007.

(51) Int. Cl. B32B 37/02; B32B 37/12

(52) U.S. Cl. 156/245; 156/326

(57) ABSTRACT

The use of silanes as adhesion promoters between two uncured or partially cured organic surfaces, especially such surfaces that do not adhere well to each other, and particular applications of such silanes, such as in the formation of boat hull laminates.

### BACKGROUND OF THE INVENTION

1. Field of the Invention

The present invention embodiments relate to the use of silanes as adhesion promoters between two uncured or partially cured organic surfaces, especially such surfaces that do not adhere well to each other, and particular applications of such silanes, such as in the formation of boat hull laminates.

2. Description of the Related Art

Organo-functional silanes are well-known. Organo-functional silanes generally have the formula Si(R¹)(R²)(R³)(R⁴), wherein at least one of R¹-R⁴ is a functional group. By “functional” group, it is understood that the group enables the silane to undergo a reaction, such as a condensation reaction, to form a polymer. While halogen and hydroxyl groups are functional groups, and functional silanes containing only such groups are not “organo-functional,” the quoted term is used herein to be inclusive of halogen and hydroxyl groups.

Silane coupling agents generally belong to a class of organosilane compounds having at least two reactive groups of different types bonded to the silicon atom in a molecule, i.e., at least two different types of functional or reactive groups selected from R¹-R⁴ are present in the silane. One of the reactive groups, such as methoxy, ethoxy and silanolic hydroxy groups, is reactive with various inorganic materials such as glass, metals, silica sand and the like to form a chemical bond with the surface of the inorganic material while the other of the reactive groups, such as vinyl, epoxy, (meth)acryl, amino and mercapto groups, is reactive with various kinds of organic materials or synthetic resins to form a chemical bond. The methoxy, ethoxy and silanolic hydroxy groups are examples of hydrolyzable groups and are thus reactive in the presence of water.

As a result of possessing these two types of reactive groups, silane coupling agents are capable of providing chemical bonding between an organic material and an inorganic material. Examples of such silane coupling agents include 3-aminopropyltrimethoxysilane (which contains amine and methoxy reactive groups); 3-glycidoxypropyltrimethoxysilane (which contains epoxy and methoxy reactive groups); 3-mercaptopropyltrimethoxysilane (which contains mercapto and methoxy reactive groups); and 3-(meth)acryloxypropyltrimethoxysilane (which contains (meth)acrylate and methoxy reactive groups).

The above silanes are only exemplary, and one skilled in the art could choose other silane coupling agents. Condensation reactions involving such silanes may be carried out in the presence of catalysts, which are well-known. Such catalysts include, for example, tin, and titanium-containing catalysts.

Such silanes are well-documented in the patent and other literature. Examples of useful silanes are described in U.S. Pat. No. 6,221,944 and U.S. Published Patent Application 2001/0032568. See generally Kirk-Othmer Encyclopedia of Chemical Technology, 4^{th} Edition, Volume 21, pages 654-657, John Wiley & Sons (1997).

The use of gel coats, and particularly polyester, such as unsaturated polyester, gel coats, to coat boat hull substrates, such as substrates based on glass- or other fiber-reinforced polyester, are known. Typically, such coatings are formed by applying the gel coat precursor to a mold first. Before the gel coat precursor has been fully cured, the boat hull substrate is then applied over the gel coat precursor, after which curing is completed. Such a method is well-known in the art, as described in, for example, the following U.S. patents: U.S. Pat. No. 4,120,749; U.S. Pat. No. 4,495,884; U.S. Pat. No. 5,164,127; U.S. Pat. No. 5,697,319; U.S. Pat. No. 6,235,228; U.S. Pat. No. 6,617,395; U.S. Pat. No. 6,726,865; and U.S. Pat. No. 6,773,655.

Epoxy composite hulls, i.e., hulls based on glass- or other fiber-reinforced epoxy, in place of glass- or other fiber-reinforced polyester hulls, are growing in so-called high-end boats, especially speed boats, because the epoxy has an effect of making the hull stronger and lighter. For example, U.S. Published Patent Application 2003/0124355 discloses what is alleged to be a novel epoxy resin-containing composition for use, inter alia, in aviation or marine applications, such as boat hulls.

However, it has been difficult to achieve the level of polyester gel coat adhesion with the epoxy-based hull customarily obtained using the earlier polyester-based hull. Thus, there is a need in the art to find ways of fabricating glass- or other fiber-reinforced epoxy boat hull substrates with a gel coat, such as a polyester gel coat, which achieves a level of adhesion obtained with the glass- or other fiber-reinforced polyester substrate hulls.

According to U.S. Published Patent Application 2006/0196404, it is standard in the boating industry to form a so-called tie coat layer between the outer gel coat and the epoxy-containing layer. The tie coat is characterized therein as in the form of an unsupported spray which is sprayed onto the inner surface of the gel coat. In this U.S. Published Patent Application, a vinyl ester layer is used in place of the tie layer. Particularly, the vinyl ester layer is chemically bonded to a polyester resin-based outer gel coat layer, and a fiberglass-impregnated epoxy layer is chemically bonded to the vinyl ester layer.

Still, there is a need in the art to achieve a level of adhesion of a gel coat to a glass- or other fiber-reinforced epoxy substrate that does not rely on a tie-coat or other intermediate layer.

It is not believed that silane condensation technology has been used in the boat hull art generally for adhering layers, let alone to effect a greater adhesion between glass- or other fiber-reinforced epoxy boat hull substrates and polymer-based, such as polyester-based, gel coats. Nor is it known to what extent, if any, silane condensation technology has been used to improve the adhesive bond between two organic surfaces, especially such organic surfaces that do not adhere well to each other, i.e., referred to below as incompatible organic surfaces, regardless of application. Thus, the present invention is intended to supplement other means that have been used in the prior art to improve the adhesive bond between incompatible organic surfaces, such as the use of tie layers and corona treatment.

### DETAILED DESCRIPTION OF THE EMBODIMENTS OF THE INVENTION

The embodiments of the present invention are drawn to the use of above-described silane condensation technology to effect improvement in the adhesion of two organic surfaces, especially such surfaces that do not adhere well to each other, i.e., incompatible surfaces. The organic surfaces each comprise one or more resins based on one or more polymers or copolymers (polymer hereinafter).

Particularly, the present inventions are drawn to the use of silanes previously disclosed as coupling agents between organic and inorganic surfaces. In the present invention, the silane has at least one hydrolyzable group, e.g., a halogen and/or an OR group, wherein R is, for example, alkyl, arylalkyl, aryl, and alkylaryl, and at least one organofunctional group, i.e., Y group (other than, for example, OR or halogen), such as vinyl, epoxy, (meth)acryl, amino and mercapto groups. When hydrolysis occurs, the OR or halogen groups become OH groups, thus forming Si—OH, or silanol, groups, as is well-known.

Thus, the silanes of the present invention include monosilanes having the formula Si(Z)_{z}(Y)_{y}(X)ₓ, wherein Z is a hydrolyzable group, Y is as described above, and X is a nonreactive group, such as alkyl, arylalkyl, aryl, and alkylaryl, x is 0-2, y is 1-3, z is 1-3, and the sum of x, y and z is 4.

The Y group of a particular silane is determined by its compatibility or reactivity with the polymer of the surface for which the silane is to act as the adhesion promoter. When the surfaces, respectively, are incompatible, the Y group(s) of the silane for the respective surface will usually be different. However, in cases where the Y group is compatible or reactive with the polymer of each surface, the silane for each surface may have the same Y group.

In operation, and while not being limited to a particular theory, the Z groups of the respective silanes will hydrolyze, whereby siloxane bonds, i.e., Si—O—Si will form between the silane attached to one surface by virtue of the compatibility or reactivity of the Y group with the polymer of this surface, and the silane attached to the other surface by virtue of the compatibility or reactivity of the Y group with the polymer of that surface.

Analogous di-, tri- and higher or oligomeric-silanes may also be used, as is well-known, and are thus within the terms of the present invention, so long as the requisite Z and Y groups are present to enter into the corresponding reactions.

The following five methods of applying the silanes of the present invention to two different organic surfaces is described, although the methods are not intended to be limited thereto. The silane compatible or reactive with a first surface is referred as the first silane; the silane compatible or reactive with a second surface is referred as the second silane. One or a mixture of silanes may be used as the first silane provided appropriate Y groups are present. Similarly, one or a mixture of silanes may be used as the second silane provided appropriate Y groups are present.

In the first method, each silane is added to the components of the respective layers, prior to carrying out the usual method of bonding such layers. Any or all of the silanes may be hydrolyzed prior to, or after, incorporating it (them) with the applicable components.

In the second method, the first silane is added to the components of the first layer, as in the first method. Then, a primer containing the second silane is applied to the first layer, and no more than partial curing is carried out. Then, the components of the second layer are applied, and final curing is carried out.

In the third method, the first layer is applied without the first silane. Then, a primer containing the first silane is applied to the first layer, and no more than partial curing is carried out. Then, the components of the second layer containing the second silane are applied, and final curing is carried out.

In the fourth method, the first layer is applied without the first silane. Then, a primer containing both the first and second silane is applied to the first layer, and no more than partial curing is carried out. Then, the components of the second layer without the second silane are applied, and final curing is carried out.

In the fifth method, a variation of the above four methods is carried out. The first layer is applied without a silane. Then a primer containing siloxane bonds and at least two Y groups, at least one of which is compatible or reactive with the polymer of the first layer, and at least one of which is compatible or reactive with the polymer of the second layer, is applied to the first layer, and no more than partial curing is carried out. Then, the components of the second layer without a silane are applied, and final curing is carried out.

While the fifth method is described as using a primer containing siloxane bonds, any compound which will enter into a reaction via its Y group(s) with respective organic surfaces is deemed to be included as an embodiment of the present invention.

In above second through fifth methods, the primer acts as a vehicle for the silane(s) and be a solution thereof or in any other suitable form.

There is no limitation on the curing temperature so long as curing is successfully carried out. Curing temperatures as a high as 200° C. or greater are applicable, but room temperature curing is preferable.

Other silanes, i.e., silanes that do not have both the prerequisite Z and Y groups, may be present so long as they do not prevent the object described herein from being carried out.

The method of the present invention may be used in all possible situations where the adhesive bond between two incompatible organic surfaces is in need of improvement.

In a preferred embodiment, the method of the present invention is used to form boat hull laminates. Thus, the first layer may be a polyester-based, such as an unsaturated polyester-based, gel coat; the second layer may be a glass- or other fiber-reinforced epoxy boat hull substrate; the only limitation being that the respective silanes in each layer have suitable Y groups and are capable of entering into a condensation reaction with each other, and then conventional boat hull technology is carried out in order to laminate the glass- or other fiber-reinforced epoxy layer to the gel coat layer.

Thus, this embodiment is inclusive of a method which comprises incorporating a first silane into a polyester-based gel coat precursor, applying the gel coat precursor to the inside of a mold, partially curing said gel coat precursor thereby forming a partially cured polyester-based gel coat layer, incorporating a second silane into a glass- or other fiber-reinforced epoxy layer, applying said epoxy layer to said partially cured polyester-based gel coat layer, and completing said curing.

The method may be carried out by any known method in the art for laminating glass- or other fiber-reinforced epoxy layer to a polyester-based gel coat layer, such as those described in the above-listed U.S. Patents and U.S. Published Patent Application.

This embodiment is inclusive of all polyester-based gel coat materials known in the art and all glass- or other fiber-reinforced epoxy materials known in the art.

Any of the above-described five methods may be used to carry out this preferred embodiment.

In another preferred embodiment, an amino-substituted silane is incorporated into the glass- or other fiber-reinforced epoxy layer, and a vinyl-substituted or (meth)acryl-substituted silane is incorporated into the gel coat layer.

In addition, while the above-described embodiments describe the use of polyester-based gel coats, other embodiments include the use of gel coats other than those that are polyester-based. For example, above-referenced U.S. Pat. No. 5,164,127 describes gel coats derived from vinyl esters and epoxies. Thus, this embodiment is inclusive of all conventional gel coat materials.

The method of the present invention is not limited to particular organic surface materials and other resins than those already described, such as polyurethanes, may be used where applicable.

Examples of silanes which can be used in all of the embodiments of the present invention include 3-aminopropyltriethoxysilane, 3-aminopropyltrimethoxysilane, 2-aminoethyl-3-aminopropyltrimethoxysilane, triamino-functional propyltrimethoxysilane, 3-glycidyloxypropyltriethoxysilane, 3-glycidyloxypropyltrimethoxysilane, bis(3-triethoxysilylpropyl)amine, bis(3-trimethoxysilylpropyl)amine, 2-aminoethyl-3-aminopropylmethyldimethoxysilane, N-(n-butyl)-3-aminopropyltrimethoxysilane, 3-aminopropylmethyldiethoxysilane, 3-ureidopropyltriethoxysilane, polyether-functional trimethoxysilane, aqueous aminosilane hydrolysate, aqueous amino/alkyl-functional siloxane co-oligomer, vinyltriethoxysilane, vinyltrimethoxysilane, vinyltris(2-methoxyethoxy)silane, vinyltrimethoxysilane oligomer, vinyltriethoxysilane oligomer, and functional oligosiloxanes.

However, the above are only exemplary; no limitation is placed on the silanes used so long as they are capable of carrying out the objects described above. The above-described U.S. patents and U.S. published patent applications are all incorporated by reference herein. In addition, U.S. provisional application 60/913,559 is incorporated by reference herein.

1. A method of improving the adhesion to each other of organic polymer-containing surfaces of two layers, comprising bonding the layers through the reaction of at least two different hydrolysable silanes, wherein at least a hydrolysable first silane is compatible or reactive with a polymer of one of said surfaces and at least a hydrolysable second silane is compatible or reactive with a polymer of the other of said surfaces.

2. The method of claim 1, wherein the hydrolysable silanes are selected from the group consisting of monosilanes having the formula Si(Z)_{z}(Y)_{y}(X)ₓ, wherein Z is a hydrolyzable group, Y is an organofunctional group different from Z, and X is a nonreactive group, x is 0-2, y is 1-3, z is 1-3, and the sum of x, y and z is 4; and analogous di-, tri- and higher or oligomeric-silanes thereof.

3. The method of claim 1 or 2, wherein each hydrolysable silane is added to the components of the respective layers, prior to bonding said layers.

4. The method of claim 1 or 2, wherein the first hydrolysable silane is added to components of a layer, a primer containing the hydrolysable second silane is applied to this layer, no more than partial curing is carried out, components of the other layer are applied, and final curing is carried out.

5. The method of claim 1 or 2, wherein a layer is applied without the hydrolysable first silane, a primer containing the hydrolysable first silane is applied to this layer, no more than partial curing is carried out, components of the other layer containing the hydrolysable second silane are applied, and final curing is carried out.

6. The method of claim 1 or 2, wherein a layer is applied without the first hydrolysable silane, a primer containing both the hydrolysable first and second silanes is applied to this layer, no more than partial curing is carried out, components of the other layer without the hydrolysable second silane are applied, and final curing is carried out.

7. The method of claim 2, wherein a layer is applied without a hydrolysable silane, a primer containing siloxane bonds and at least two Y groups, at least one of which is compatible or reactive with the polymer of the surface of one layer, and at least one of which is compatible or reactive with the polymer of the surface of the other layer, is applied to the one layer, no more than partial curing is carried out, components of the other layer without a hydrolysable silane are applied, and final curing is carried out.

8. The method of any of claims 1 to 7, wherein the two layers are layers of a boat hull laminate.

9. The method of claim 8, wherein one layer is a polyester-based gel coat and the other layer is a glass- or other fiber-reinforced epoxy boat hull substrate.

10. The method of claim 9, which comprises incorporating a hydrolysable first silane into a polyester-based gel coat precursor, applying the gel coat precursor to the inside of a mold, partially curing said gel coat precursor thereby forming a partially cured polyester-based gel coat layer, incorporating a hydrolysable second silane into a glass- or other fiber-reinforced epoxy layer, applying said epoxy layer to said partially cured polyester-based gel coat layer, and completing said curing.

11. The method of claim 9 or 10, wherein an amino-substituted silane is incorporated into the glass- or other fiber-reinforced epoxy layer, and a vinyl-substituted or (meth)acryl-substituted silane is incorporated into the gel coat layer.

12. The method of any of claims 1 to 11, wherein the hydrolysable first silane is selected from the group consisting of 3-(meth)acryloxypropyltrimethoxysilane, 3-(meth)acryloxypropyltriethoxysilane, 3-(meth)acryloxyisobutyltrimethoxysilane, 3-(meth)acryloxyisobutyltriethoxysilane, vinyltrimethoxysilane, vinyltriethoxysilane, and mixtures thereof, and the hydrolysable second silane is selected from the group consisting of 1-aminomethyltrimethoxysilane, 1-aminomethyltriethoxysilane, 2-aminoethyltrimethoxysilane, 2-aminoethyltriethoxysilane, 3-aminopropyltrimethoxysilane, 3-aminopropyltriethoxysilane, 3-(N-n-butylamino)propyltrimethoxysilane, 3-(N-n-butylamino)propyltriethoxysilane, 3-aminoisobutyltrimethoxysilane, 3-aminoisobutyltriethoxysilane, N-[2-aminoethyl]-3-aminopropyltrimethoxysilane, N-[2-aminoethyl]-3-aminopropyltriethoxysilane, and mixtures thereof.
